(19) United States
(12) Patent Application Publication
(10) Pub. No.: US 2007/0158119 A1
(43) Pub. Date: Jul. 12, 2007

(54) Independent axle motors for a road coupled hybrid vehicle

(76) Inventor: David M. Pascoe, Newmarket (CA)

Correspondence Address: HARNESS, DICKEY & PIERCE, P.L.C., P.O. BOX 828, BLOOMFIELD HILLS, MI, 48303, US

(21) Appl. No.: 11/645,186

(22) Filed: Dec. 22, 2006

Related U.S. Application Data
(60) Provisional application No. 60/756,880, filed on Jan. 6, 2006.

(51) Int. Cl. B60K 6/00

(52) U.S. Cl. 180/65.2

(57) ABSTRACT

A hybrid vehicle having first, second, third and fourth drivable wheels includes an internal combustion engine selectively drivingly coupled to the first and second wheels. A first electric motor is selectively drivingly coupled to the third vehicle wheel. A second electric motor is selectively drivingly coupled to the fourth vehicle wheel.

### CROSS-REFERENCE TO RELATED APPLICATIONS

This application claims the benefit of U.S. Provisional Application No. 60/756,880, filed on Jan. 6, 2006. The disclosure of the above application is incorporated herein by reference.

### BACKGROUND AND SUMMARY OF THE INVENTION

The present disclosure generally relates to hybrid vehicles and, more particularly, to hybrid vehicles having independently operable electric drive motors.

Many automotive vehicles include an internal combustion engine as the sole power source for providing drive torque to one or more sets of wheels. To achieve a variety of environmental and fuel economy goals, some vehicles have been configured to include multiple sources of motive power. In one known example, a hybrid vehicle utilizes an internal combustion engine and an electric motor. The electric motor provides power to both rear wheels through a common driveshaft coupled to a differential. While this arrangement may have merit, unless some form of traction control is implemented, wheel slippage may occur at the wheel with the lowest traction. Furthermore, the differential may be relatively costly and add undesirable weight to the vehicle.

Another known hybrid vehicle includes multiple electric motors coupled and individually mounted to driven wheels in an attempt to solve the problem of independent wheel torque control. Unfortunately, this arrangement adds an unacceptable amount of unsprung weight to each wheel.

Accordingly, there is a need for alternative hybrid drive arrangements complementing existing internal combustion engine power transfer systems.

The disclosure presents a hybrid vehicle having first, second, third and fourth drivable wheels. The hybrid vehicle includes an internal combustion engine operable for selectively driving the first and second wheels. A first electric motor is operable for selectively driving the third vehicle wheel while a second electric motor is operable for selectively driving the fourth vehicle wheel.

Various arrangements of the internal combustion engine and the first and second electric motors are disclosed to provide a vehicle that may be selectively driven by one, two or four wheels. Specifically, hybrid vehicles having a forward mounted internal combustion engine and rearward mounted electric drive motors are disclosed. In addition, a hybrid vehicle having a rearward mounted internal combustion engine with electric drive motors providing torque to steerable front wheels is also disclosed. Yet another hybrid vehicle having a longitudinally-oriented forward mounted internal combustion engine driving the rear wheels is shown to include two electric motors individually driving the front steerable wheels of the vehicle. The electric motors may be coupled to the vehicle body, frame or subframe and provide independent torque to each wheel without adding unsprung mass.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic plan view of a vehicle equipped with a first embodiment hybrid drive system;

FIG. 2 is a schematic plan view of a vehicle equipped with an alternate embodiment hybrid drive system;

FIG. 3 is a schematic plan view of a vehicle equipped with an alternate embodiment hybrid drive system;

FIG. 4 is a schematic plan view of a vehicle equipped with an alternate embodiment hybrid drive system; and

FIG. 5 is a schematic plan view of a vehicle equipped with an alternate embodiment hybrid drive system.

### DETAILED DESCRIPTION

The following description is merely exemplary in nature and is not intended to limit the present disclosure, application, or uses.

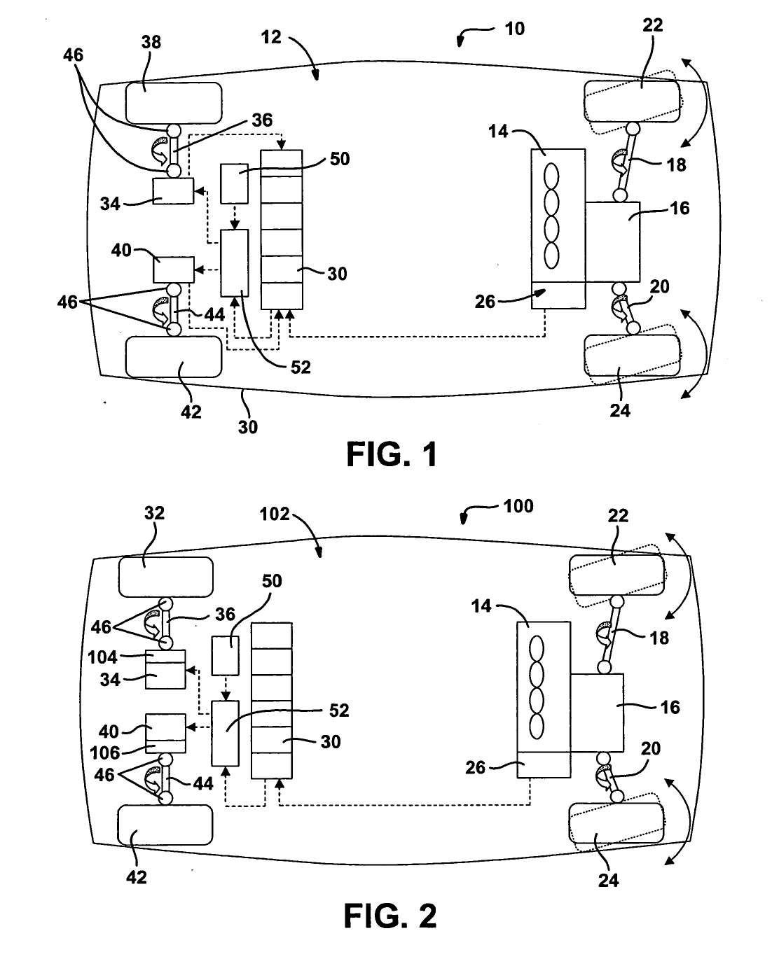

FIG. 1 depicts a first embodiment hybrid vehicle 10 equipped with a hybrid drive system 12. Hybrid drive system 12 includes an internal combustion engine 14 drivingly coupled to a transmission 16. Internal combustion engine 14 is mounted transversely in a forward portion of vehicle 10. Transmission 16 provides output torque to a first front drive shaft 18 and a second front drive shaft 20 for driving front wheels 22 and 24, respectively. An electric drive such as a starter/generator 26 is coupled to internal combustion engine 14. If electrical energy is provided to starter/generator 26, a crankshaft (not shown) of internal combustion engine 14 is rotated to assist in starting the internal combustion engine. Alternatively, when internal combustion engine 14 is operating by combusting fuel, starter/generator 26 is selectively operable to provide current to a battery pack 30.

Hybrid drive system 12 also includes a first electric motor 34 selectively operable to provide output torque to a first rear driveshaft 36 and a first rear wheel 38. In similar fashion, a second electric motor 40 is selectively operable to provide output torque to a second rear wheel 42 via a second rear driveshaft 44. The ends of first rear driveshaft 36 and second rear driveshaft 44 are equipped with universal joints 46. Universal joints 46 are operable to transmit rotary power at various angles of articulation. In this manner, relative movement between first rear wheel 38 and first electric motor 34 may be accommodated. With this type of interconnection, first electric motor 34 may be mounted to the vehicle body or frame in an unsprung arrangement while first rear wheel 38 is sprung from the vehicle frame using a suspension. Second rear wheel 42 may also be independently suspended from the vehicle frame while second electric motor 40 is mounted to an unsprung portion of vehicle 10. Vehicle handling characteristics are improved by minimizing the amount of unsprung weight.

A computer control module 50 is operable to independently control first electric motor 34 and second electric motor 40. Computer control module 50 may be in communication with a vehicle controller (not shown) to determine when each motor should be energized. The independent motor arrangement and control allows greater vehicle control by providing the appropriate torque to the wheels independently. A power electronics control module 52 is in communication with computer control module 50. Based on instructions given by computer control module 50, power electronics control module 52 manages a high power supply of electrical energy provided by battery pack 30.

First electric drive motor 34 and second electric motor 40 may also be operated in a regenerative mode where energy from the moving vehicle is converted to electrical energy. Battery 30 may be recharged through the use of motors 34 and 40 in the regenerative mode.

FIG. 2 depicts another alternate embodiment hybrid vehicle 100 equipped with a hybrid drive system 102. Hybrid drive system 102 is substantially similar to hybrid drive system 12. Accordingly, like elements will retain their previously introduced reference numerals. Hybrid drive system 102 includes a first gear reduction unit 104 drivingly coupled to first electric motor 34 and first rear driveshaft 36. First gear reduction unit 104 is operable to accept a relatively high speed, low torque input from first electric motor 34 and provide a relatively low speed, high torque output to first rear driveshaft 36. It is contemplated that first electric motor 34 and second electric motor 40 will provide output torque during vehicle acceleration, performance cornering and limited traction conditions. It is also contemplated that the electric drive motors 34, 40 may provide the primary motive force during stop and go driving in order to improve fuel economy and reduce internal combustion engine emissions. A second gear reduction unit 106 is drivingly coupled to second electric motor 40 and second rear driveshaft 44. Second gear reduction unit 106 performs substantially similarly to first gear reduction unit 104.

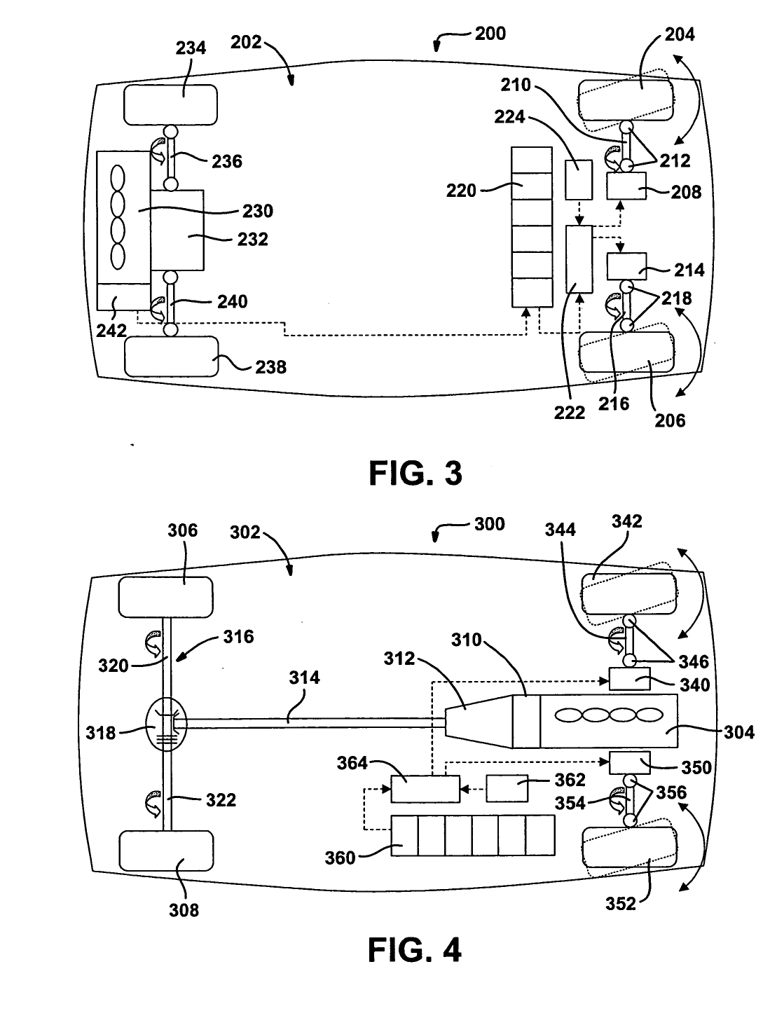

FIG. 3 shows another alternate embodiment vehicle 200 equipped with a hybrid drive system 202. Vehicle 200 includes steerable and drivable front wheels 204 and 206. Front wheel 204 is independently provided torque by a first electric drive motor 208. A first driveshaft 210 interconnects front wheel 204 and first electric drive motor 208 using a pair of constant velocity joints 212. In similar fashion, a second electric drive motor 214 selectively provides drive torque to driven front wheel 206. A second driveshaft 216 is drivingly coupled to second electric drive motor 214 and wheel 206 via a pair of constant velocity joints 218. A battery pack 220 provides power to a power electronics control module 222. A controller 224 is in communication with power electronics control module 222 to selectively provide instructions regarding the power supply to first electric drive motor 208 and second electric drive motor 214. Power electronics control module 222 is operable to independently operate first electric drive motor 208 and second electric drive motor 214.

An internal combustion engine 230 is operable to provide output torque to a transmission 232. Internal combustion engine 230 is transversely mounted in a rearward portion of vehicle 200. Transmission 232 is drivingly coupled to a first rear drive wheel 234 via a driveshaft 236. Transmission 232 is drivingly coupled to a second rear drive wheel 238 via a second rear driveshaft 240. A starter/generator 242 is mounted to internal combustion engine 230 to selectively rotate a crankshaft (not shown) of internal combustion engine 230 during starting. Starter/generator 242 may also operate as a generator after the internal combustion engine has been started.

FIG. 4 depicts another alternate embodiment vehicle 300 equipped with a hybrid drive system 302. Hybrid drive system 302 is contemplated for use with a vehicle having a forward mounted, longitudinally oriented, internal combustion engine 304 providing drive torque to a first rear wheel 306 and a second rear wheel 308. Internal combustion engine 304 is drivingly coupled to a clutch 310 selectively operable to provide output torque to a transmission 312. The output of transmission 312 is coupled to a propeller shaft 314. Propeller shaft 314 is drivingly interconnected to a rear axle 316 having a differential 318 operable to provide output torque to a first axle shaft 320 and a second axle shaft 322. First axle shaft 320 provides drive torque to first rear wheel 306 while second axle shaft 322 provides drive torque to second rear wheel 308. A first electric drive motor 340 is operable to selectively and independently provide drive torque to a first driven and steerable front wheel 342. A first front driveshaft 344 is drivingly coupled to steerable front wheel 342 and first electric drive motor 340 by a pair of constant velocity joints 346.

A second electric drive motor 350 is independently operable to provide drive torque to a second steerable and drivable front wheel 352. A second driveshaft 354 drivingly interconnects second electric drive motor 350 and second front wheel 352. A constant velocity joint 356 is mounted at each end of driveshaft 354 to allow suspension articulation and steering movement of second front wheel 352 while drive torque is being transferred.

A battery pack 360, a computer control module 362 and a power electronics control module 364 cooperate to selectively provide first electric drive motor 340 and second electric drive motor 350 with current to generate a desired amount of torque at their respective wheel ends. Motors 340 and 350 may also be operated in a regenerative mode to charge battery 360 when vehicle 300 is moving. The regenerative mode may be entered when the vehicle is accelerating, operating at a constant speed, coasting or braking.

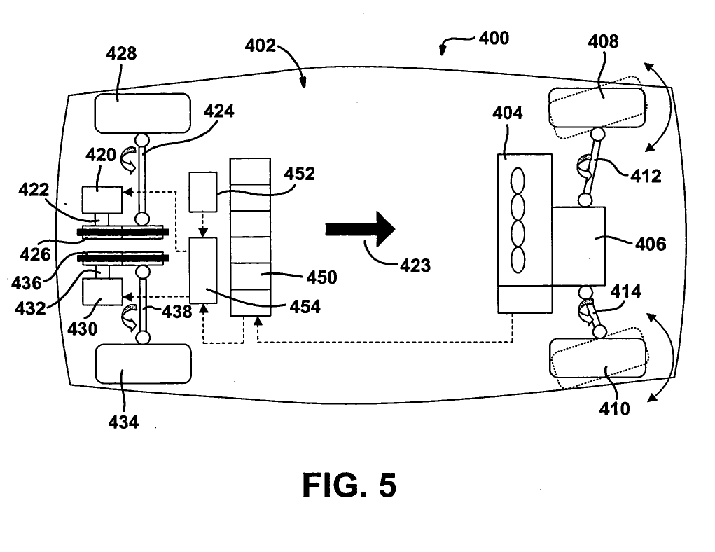

FIG. 5 shows another alternate embodiment vehicle 400 having a hybrid drive system 402. Vehicle 400 includes a transversely oriented internal combustion engine 404 mounted in a forward portion of the vehicle. Internal combustion engine 404 is operable to transfer torque through a transmission 406 to a first driven and steerable front wheel 408 and a second driven and steerable front wheel 410. Driveshafts 412 and 414 transfer torque from transmission 406 to driven front wheels 408 and 410, respectively.

A first electric drive motor 420 includes an output shaft 422 laterally extending across vehicle 400. Accordingly, output shaft 422 rotates about an axis extending substantially perpendicular to the forward direction of vehicle travel as indicated by an arrow 423. Output shaft 422 is drivingly coupled to a driveshaft 424 via a first power transfer mechanism 426. Power transfer mechanism 426 may include any number of power transmission elements such as pulleys and a belt, sprockets and a chain, meshed gears or a number of similar elements. Driveshaft 424 rotates about an axis substantially parallel to and longitudinally offset from the axis of rotation of output shaft 422. Driveshaft 424 provides torque to a first driven rear wheel 428. By mounting the first electric drive motor 420 offset from and parallel to driveshaft 424, the length of driveshaft 424 may be increased. An increased driveshaft length reduces the maximum articulation angle observed at the ends of driveshaft 424 during suspension travel of drive wheel 428.

A second electric drive motor 430 includes a rotatable output shaft 432 aligned with output shaft 422 of first electric drive motor 420. Output shaft 432 of second electric drive motor 430 is drivingly coupled to a second rear driven wheel 434. A second power transfer mechanism 436 drivingly interconnects output shaft 432 and a second driveshaft 438. As mentioned earlier with reference to first power transfer mechanism 426, second power transfer mechanism 436 may include power transmission components such as belts, chains or gears. The output member of second power transfer mechanism 436 is drivingly coupled to one end of driveshaft 438. The opposite end of driveshaft 438 is coupled to second rear driven wheel 434.

A battery 450 provides electrical power to first electrical drive motor 420 and second electric drive motor 430. A computer control module 452 communicates with a power electronics control module 454 and is operable to selectively actuate and individually control each of the first and second electric motors 420 and 430, respectively.

Furthermore, the foregoing discussion discloses and describes merely exemplary embodiments of the present invention. One skilled in the art will readily recognize from such discussion, and from the accompanying drawings and claims, that various changes, modifications and variations may be made therein without department from the spirit and scope of the invention as defined in the following claims.

What is claimed is:

1. A drive train arrangement for a motor vehicle having first, second, third, and fourth wheels, the drive train arrangement comprising:
an internal combustion engine adapted to provide drive torque to the first and second vehicle wheels;
a first electric motor adapted to provide drive torque to the third vehicle wheel; and
a second electric motor adapted to provide drive torque to the fourth vehicle wheel.

2. The drive train arrangement of claim 1 wherein the first and second electric motors are not operable to provide drive torque to the first and second vehicle wheels.

3. The drive train arrangement of claim 2 wherein the internal combustion engine is not operable to provide drive torque to the third and fourth vehicle wheels.

4. The drive train arrangement of claim 1 wherein the internal combustion engine is adapted to provide drive torque to the front wheels of the vehicle.

5. The drive train arrangement of claim 1 wherein the first and second electric motors include output shafts rotating about axes extending perpendicular to a forward direction of vehicle travel.

6. The drive train arrangement of claim 5 wherein the output shaft of the first electric motor extends substantially parallel to and longitudinally offset from a driveshaft drivingly interconnecting the first electric motor and the third vehicle wheel.

7. The drive train arrangement of claim 1 wherein the first and second electric motors are selectively operable as generators to provide a charging current to a battery.

8. The drive train arrangement of claim 1 wherein the first and second electric motors are directly mounted to a frame of the vehicle, each of the third and fourth vehicle wheels being supported from the frame by a spring.

9. The drive train arrangement of claim 1 further including a first gear reduction unit drivingly interconnecting an output shaft of the first electric motor with the third vehicle wheel and a separate and spaced apart second gear reduction unit drivingly interconnecting an output shaft of the second electric motor with the fourth vehicle wheel.

10. The drive train arrangement of claim 1 wherein the first and second vehicle wheels are steerable front wheels.

11. The drive train arrangement of claim 1 wherein the third and fourth vehicle wheels are steerable front wheels.

12. The drive train arrangement of claim 11 wherein the internal combustion engine is longitudinally oriented and transversely positioned between the first and second electric motors.

13. The drive train arrangement of claim 12 wherein a driveshaft longitudinally extends to drivingly interconnect the internal combustion engine and a rear axle assembly providing drive torque to both of the first and second vehicle wheels.

14. The drive train arrangement of claim 11 wherein the internal combustion engine is transversely oriented.

15. The drive train arrangement of claim 14 wherein the internal combustion engine is positioned rearward of the first, second, third and fourth vehicle wheels.

16. A hybrid vehicle comprising:
first, second, third and fourth drivable wheels;
an internal combustion engine selectively drivingly coupled to the first and second vehicle wheels;
a first electric motor selectively drivingly coupled to the third vehicle wheel;
a second electric motor selectively drivingly coupled to the fourth vehicle wheel; and
an electric device operable to rotate a crankshaft of the internal combustion engine during a starting mode, the electric device also being operable to output a charging current to a battery during a recharging mode.

17. The hybrid vehicle of claim 16 wherein the internal combustion engine is located rearward of rear driving axles coupled for rotation with the first and second vehicle wheels and wherein the third and fourth vehicle wheels are located at a front of the vehicle.

18. The hybrid vehicle of claim 17 wherein the first and second electric motors include output shafts rotating about axes extending perpendicular to a forward direction of vehicle travel.

19. The hybrid vehicle of claim 16 wherein the output shaft of the first electric motor extends substantially parallel to and offset from a driveshaft drivingly interconnecting the first electric motor and the third vehicle wheel.

20. The hybrid vehicle of claim 19 further including a power transmission mechanism drivingly interconnecting the output shaft of the first electric motor and the driveshaft.

21. The hybrid vehicle of claim 16 wherein the internal combustion engine is longitudinally oriented and transversely positioned between the first and second electric motors.

22. The hybrid vehicle of claim 16 wherein the first and second electric motors are selectively operable as generators to provide a charging current to the battery.

23. The hybrid vehicle of claim 16 wherein the first and second electric motors are not operable to provide drive torque to the first and second vehicle wheels.
